(19) United States
(12) Patent Application Publication
(10) Pub. No.: US 2018/0239350 A1
(43) Pub. Date: Aug. 23, 2018

(54) SYSTEMS AND METHODS FOR DELIVERING MERCHANDISE USING UNMANNED AERIAL VEHICLES

(71) Applicant: Wal-Mart Stores, Inc., Bentonville, AR (US)

(72) Inventor: Robert L. Cantrell, Herndon, VA (US)

(21) Appl. No.: 15/877,949

(22) Filed: Jan. 23, 2018

Related U.S. Application Data
(60) Provisional application No. 62/461,330, filed on Feb. 21, 2017.

(51) Int. Cl. G05D 1/00; G05D 1/10; B64C 39/02; B64D 45/04

(52) U.S. Cl. CPC G05D 1/0022; G05D 1/0088; G05D 1/101; G05D 1/0027; B64C 2201/141; B64C 39/024; B64D 45/04; B64C 2201/128; B64C 2201/146; G05D 1/0094

(57) ABSTRACT

In some embodiments, apparatuses and methods are provided herein useful to deliver merchandise to landing locations. In some embodiments, there is a provided a system including: a remote navigational control system operable by a human pilot to control a flight of an unmanned aerial vehicle (UAV) with the UAV including: a two-way communication unit; a sensor configured to capture images; and a control circuit. The UAV control circuit is configured to: autonomously navigate the UAV along a first flight path to a navigational waypoint according to autonomous operation; communicate with the control system when the UAV arrives at the navigational waypoint; await instructions from the control system for landing the UAV; transmit images of the landing location to the control system; and guide the UAV along a second flight path to the landing location based on human pilot navigation instructions.

### CROSS-REFERENCE TO RELATED APPLICATION

This application claims the benefit of U.S. Provisional Application No. 62/461,330, filed Feb. 21, 2017, which is incorporated by reference in its entirety herein.

### TECHNICAL FIELD

This invention relates generally to the delivery of merchandise to customers, and more particularly, to the delivery of merchandise to customers by unmanned aerial vehicles.

### BACKGROUND

One challenge in the retail setting is the timely and efficient delivery of merchandise to customers (such as of orders placed by customers). Retailers continually seek to develop new approaches of accomplishing these deliveries. One recently developed approach for the delivery of merchandise is the use of unmanned aerial vehicles (UAVs), or drones, to transport merchandise items to a customer's residence or other delivery location. The use of UAVs to make deliveries to customers can provide a relatively low cost and timely way of completing merchandise deliveries, as well as other advantages.

The use of UAVs to make merchandise deliveries, however, presents some of its own challenges. One challenge is the navigation of the UAV the final leg of its flight to a landing location. This final leg of the flight may require more capability than the remainder of the flight. It would be desirable to develop an approach for delivering merchandise that would combine both autonomous navigation by the UAV for much of the flight and human pilot navigation for the landing.

### BRIEF DESCRIPTION OF THE DRAWINGS

Disclosed herein are embodiments of systems, apparatuses and methods pertaining to combining both autonomous and human pilot navigation of unmanned aerial vehicles to deliver merchandise to landing locations. This description includes drawings, wherein:

FIG. 1 is a schematic representation in accordance with some embodiments;

FIG. 2 is a block diagram in accordance with some embodiments;

FIG. 3 is a flow diagram in accordance with some embodiments; and

FIG. 4 is a flow diagram in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for combining both autonomous and human pilot navigation of unmanned aerial vehicles to deliver merchandise to landing locations. In some embodiments, the is provided a system including: a remote navigational control system configured to be operable by a human pilot to at least partially control a flight of an unmanned aerial vehicle; and the unmanned aerial vehicle (UAV) including: a two-way communication unit configured to communicate with the remote navigational control system; a sensor configured to capture images of a landing location; and a control circuit configured to: autonomously navigate the UAV from a first starting point along a first flight path to a navigational waypoint according to autonomous operation without any human pilot navigation from the remote navigational control system; communicate with the remote navigational control system when the UAV arrives at the navigational waypoint; await instructions from the remote navigational control system for landing the UAV when the UAV arrives at the navigational waypoint; transmit images of the landing location from the sensor to the remote navigational control system; and guide the UAV from the navigational waypoint along a second flight path to the landing location based on human pilot navigation instructions from the remote navigational control system.

In one form, the remote navigational control system may include: a communication device configured to communicate with a plurality of UAVs; and a navigation control circuit coupled to the communication device and configured to: determine a priority for landing at least one of the UAVs, each landing to be performed by one of a plurality of human pilots; and determine a queue of the at least one UAV, the queue being arranged in a landing order based on predetermined priority rules for landing and stored by the navigational control circuit.

Further, in one form, the system may include: a first priority rule to land a first subset of UAVs experiencing an emergency flight situation; wherein the remote navigational control circuit may be configured to receive a communication from the first subset indicating an emergency flight situation; wherein the remote navigational control circuit may be configured to transmit instructions from a human pilot to guide the first subset of UAVs to available landing locations; wherein the remote navigational control circuit is configured to assign priority in the queue to the first priority rule ahead of other priority rules.

In addition, in one form, the system may include: a second priority rule to land a second subset of UAVs with power levels or rates of power depletion exceeding a predetermined threshold; wherein the remote navigational control circuit may be configured to receive a communication from the second subset indicating a power level or rate of power exceeding a predetermined threshold; wherein the remote navigational control circuit may be configured to transmit instructions from a human pilot to guide each UAV of the second subset to its landing location; wherein the remote navigational control circuit may be configured to assign priority in the queue to the second priority rule after the first priority rule.

Further, in one form, the system may include: a third priority rule to land a third subset of UAVs with predetermined weather conditions within a predetermined distance of the navigational waypoint; wherein the remote navigational control circuit may be configured to determine the third subset of UAVs with the predetermined weather conditions within the predetermined distance; wherein the remote navigational control circuit may be configured to transmit instructions from a human pilot to guide each UAV of the third subset to its landing location; and wherein the remote navigational control circuit may be configured to assign priority in the queue to the third priority rule after the first and second priority rules.

Also, in one form, the system may include: a fourth priority rule to land a fourth subset of UAVs that arrive at navigational waypoints after scheduled arrival times; wherein the remote navigational control circuit may be configured to determine the scheduled arrival times of the plurality of UAVs and to determine the fourth subset; wherein the remote navigational control circuit may be configured to transmit instructions from a human pilot to guide each UAV of the fourth subset to its landing location; wherein the remote navigational control circuit may be configured to assign priority in the queue to the fourth priority rule after the first, second, and third priority rules.

Moreover, in one form, the system may include: a fifth priority rule to land a fifth subset of UAVs that have a subsequent flight scheduled; wherein the remote navigational control circuit may be configured to determine the flight schedules of the plurality of UAVs; wherein the remote navigational control circuit may be configured to transmit instructions from a human pilot to guide each UAV of the fifth subset to its landing location; wherein the remote navigational control circuit may be configured to assign priority in the queue to the fifth priority rule after the first, second, third, and fourth priority rules.

Further, in one form, the system may include: a sixth priority rule to land a sixth subset of UAVs based on length of time in the queue; wherein the remote navigational control circuit may be configured to determine the length of time of the plurality of UAVs in the queue to determine the sixth subset; wherein the remote navigational control circuit may be configured to transmit instructions from a human pilot to guide each UAV of the sixth subset to its landing location; wherein the remote navigational control circuit may be configured to assign priority in the queue to the sixth priority rule after the first, second, third, fourth, and fifth priority rules.

In addition, in one form of the system, the remote navigational control circuit may be configured to guide the UAV to the landing location using virtual reality or augmented reality devices. Also, the UAV control circuit may be configured to autonomously navigate the UAV along a third flight path from the landing location to the first starting location according to autonomous operation without any human pilot navigation from the remote navigational control system. Moreover, the remote navigational control circuit may be configured to use crowdsourcing to determine a human pilot to guide the UAV to the landing location. Further, in the system, the UAV control circuit may be configured to: return the UAV to the first starting location if the UAV control circuit cannot communicate with the remote navigational control system within a first predetermined amount of time after arriving at the navigational waypoint, a human pilot does not transmit landing instructions to the UAV within a second predetermined time after the UAV arrives at the waypoint, the power level of the UAV falls below a third predetermined minimum threshold, or the rate of power depletion of the UAV exceeds a fourth predetermined maximum threshold.

In another form, there is provided a method for combining both autonomous and human pilot navigation of unmanned aerial vehicles to deliver merchandise to landing locations, the method including: providing a remote navigational control system configured to be operable by a human pilot to at least partially control a flight of an unmanned aerial vehicle; providing an unmanned aerial vehicle (UAV) including: a two-way communication unit configured to communicate with a remote navigational control system, a sensor configured to capture images, and a control circuit operatively coupled to the two-way communication unit and the sensor; autonomously navigating the UAV from a first starting point along a first flight path to a navigational waypoint according to autonomous operation without any human pilot navigation from the remote navigational control system; communicating with the remote navigational control system when the UAV arrives at the navigational waypoint; awaiting instructions from the remote navigational control system for landing the UAV when the UAV arrives at the navigational waypoint; transmitting images of the landing location from the sensor to the remote navigational control system; determining a second flight path from the navigational waypoint to a landing location; and guiding the UAV from the navigational waypoint along a second flight path to the landing location based on human pilot navigation instructions from the remote navigational control system.

As addressed further below, this disclosure is directed generally to helping UAVs navigating obstacles near the customer delivery point for package/merchandise deliveries. Fully autonomous UAV systems may face their greatest challenge in handling the last moments before delivery. UAVs may have to navigate comparatively unfamiliar territory once they have left the major travel routes and then have to find the drop spot, assess conditions, and deliver packages among many hazards associated with the customer delivery site. In principle, the UAV may have to make the same judgements on the last few feet of delivery as a human package carrier might when pulling up to an address in a truck and delivering a package. In addition, there may be potential regulatory requirements relating to the landing of UAVs.

In one form, this disclosure attempts to solve these problems by combining autonomous UAV operation with human controlled operation. More specifically, this approach combines autonomous UAV operation with human controlled operation during the final leg of delivery, so the system makes use of human piloting capabilities to land the package. The UAV may travel to a waypoint autonomously, for example, the driveway of a house matching the customer order address. Once at the waypoint, a remote human operator may pick up the UAV, possibly using virtual reality displays, and guides the UAV on the final delivery. Such guidance could involve selecting a drop spot, finding a pre-designated drop spot, or following external guidance such as a laser. UAV pilots or operators might work at a call center-like facility where landings would be queued to the next available agent, who would land the package using the appropriate level of human control, and then send the UAV on its way for an autonomous return.

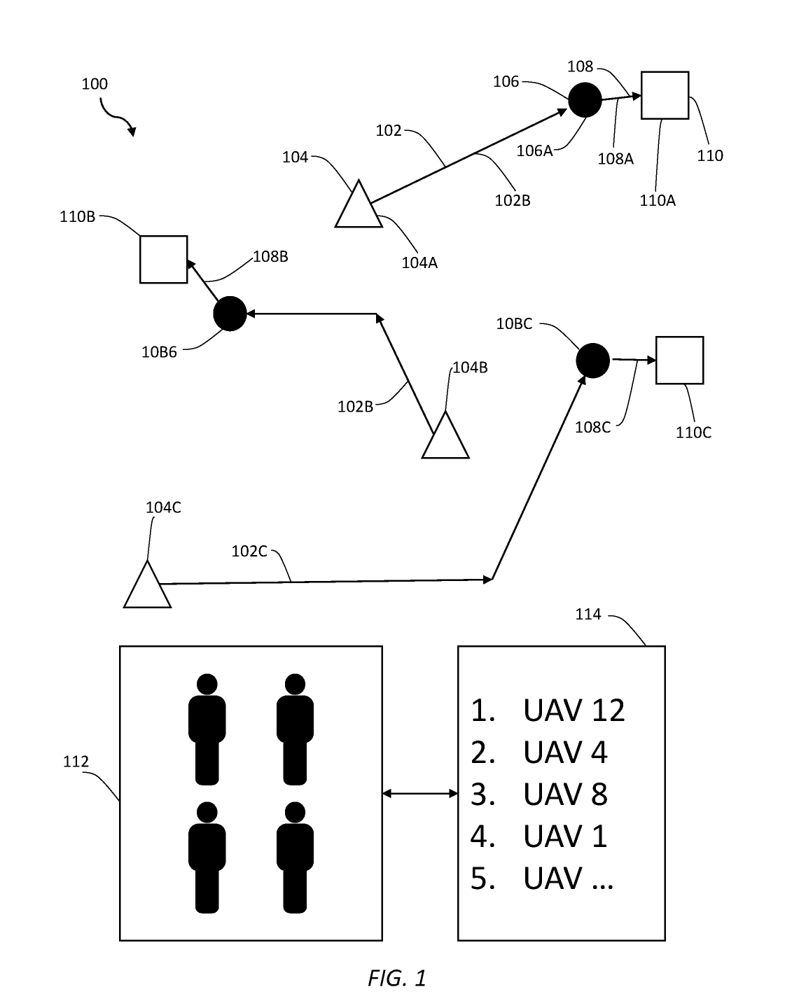

Referring to FIG. 1, there is shown a schematic representation of a system 100 for using UAVs to deliver merchandise to desired landing locations. Generally, it is contemplated that the deliveries will be made to customer residences or other customer-designated locations for delivery. As addressed further below, the system 100 is a divided control system. More specifically, the system 100 combines the autonomous operation and flight of UAVs with a human pilot for landing the UAV.

As can be seen in FIG. 1, in one form, it is generally contemplated that a plurality of UAVs will be making deliveries at any particular time. In this example, there are three UAVs that are each making deliveries along a flight path 102 from a starting location 104 to a navigational waypoint 106 and then along another flight path 108 to a delivery/landing location 110. More specifically, the first UAV travels along flight path 102A from starting location 104A to navigational waypoint 106A and then along flight path 108A to landing location 110A; the second UAV travels along flight path 102B from starting location 104B to navigational waypoint 106B and then along flight path 108B to landing location 110B; and the third UAV travels along flight path 102C from starting location 104C to navigational waypoint 106C and then along flight path 108C to landing location 110C. As addressed further below, the first flight path 102 will be handled autonomously by the UAV. It is generally contemplated that this first flight path 102 is more routine in nature and does not require any special expertise or guidance. For this reason, a preprogrammed flight plan can be used with the UAV to navigate the UAV to the navigational waypoint 106.

The second flight path 108 will not be handled autonomously but will instead be handled by human pilots 112 operating a remote navigational control system. In one form, it is contemplated that the waypoint 106 is selected to be very close to the delivery location 110, so the human pilot 112 is primarily involved in landing the UAV. It is generally contemplated that the actual landing of the UAV requires more expertise and guidance both in identifying an appropriate touchdown location for the UAV and in successfully completing the landing of the UAV without damage to the UAV. Otherwise, the touchdown location may not be selected that is near the customer residence or desired drop off location and/or may not be on suitable terrain. Because a number of deliveries may be occurring simultaneously, it is generally contemplated that a number of human pilots 112 will be available to handle the landings. Further, as addressed further below, the remote navigational control system may include a queue 114 of UAVs in which the landing order of the UAVs is prioritized. In FIG. 1, in this example, the queue 114 shows a landing order of various UAVs with different identification numbers, i.e., UAV 12 has the highest priority and is the first UAV to be landed.

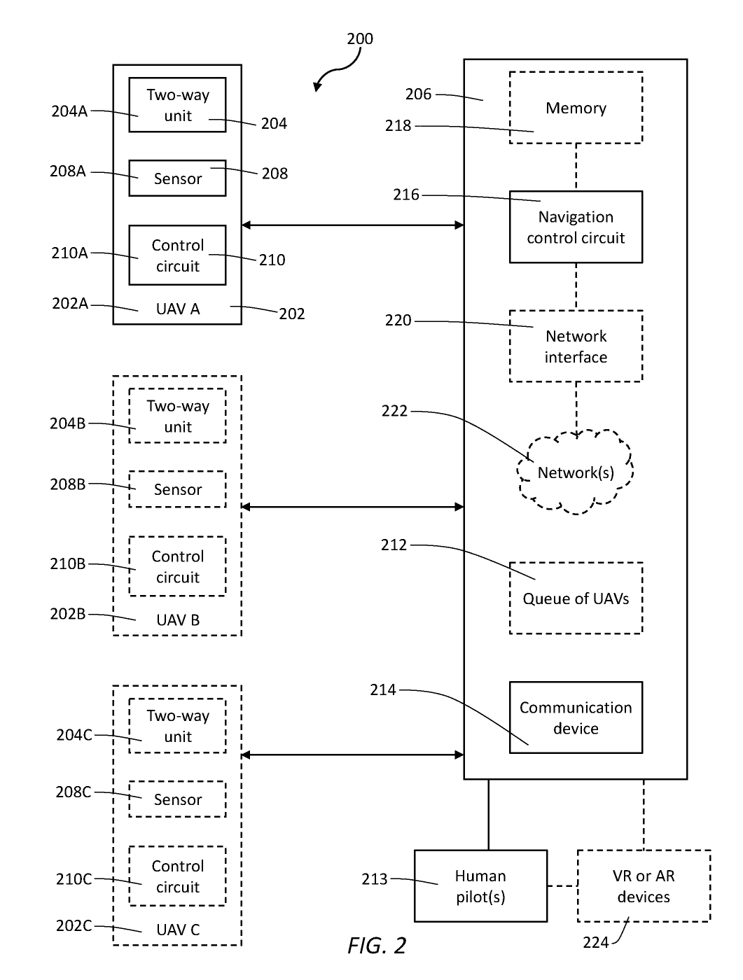

FIG. 2 shows a block diagram of some components of a system 200 for making deliveries using UAVs. It also incorporates components of system 100 shown in FIG. 1. The system 200 is a divided control system that combines both autonomous and human pilot navigation of UAVs to deliver merchandise to landing locations. As described further below, it is divided in the sense that it contemplates autonomous navigation for the first part of the delivery flight and human pilot navigation for the second part of the delivery flight.

The system 200 includes one or more UAVs 202 that are delivering merchandise to respective delivery locations. In this example, the system 200 includes three UAVs (UAV A (202A), UAV B (202B), and UAV C (202C)). As should be evident, there may be various numbers of UAVs 202 making deliveries at any one time, and, in one form, it is contemplated that many more than three UAVs may be making deliveries. Each UAV 202 includes a two-way communication unit 204 (204A/204B/204C) that communicates with a remote navigational control system 206. It is generally contemplated that that two-way communication unit 204 may be any of various conventional transceivers or communication devices that might be used to transmit and receive information and instructions with the remote navigational control system 206. For example, the two-way communication unit 204 may transmit real time flight information (such as position, heading, altitude, speed, bearing, etc.) to the remote navigational control system 206 and may receive instructions (such as landing instructions) from the control system 206. In one form, it is contemplated that the UAV may include any of various types of flight sensors (radar, LIDAR, altimeter, etc.) that collect data on flight conditions, such as to assist with autonomous navigation and/or with landing of the UAV. Further, in one form, even when a human pilot takes over control of the UAV, the avoidance control may still be handled by UAV using collision avoidance sensors, thereby serving as a safety backup.

Each UAV 202 also includes a sensor 208 (208A/208B/20C) that is used to capture images of possible touchdown locations. More specifically, it is generally contemplated that the sensor 208 will be used to capture images near a customer residence or customer-designated delivery location to suggest locations that may be suitable for a landing, and a human pilot 213 will use these images to assist in landing the UAV 202. Any of various conventional imaging sensors may be used, including any of various types of stationary or rotatable cameras, video apparatuses, etc. The sensor 208 need not be operational to continually capture images for the entirety of the delivery flight but instead is only needed to capture images at the end of the flight when the UAV 202 is landing. Accordingly, resources may be conserved by limiting the capture of images to the end of the flight.

Further, each UAV 202 includes a control circuit 210 (210A/210B/210C) that controls operation of the UAV 202. The control circuit 210 may be in wired or wireless communication with the sensor 208 and may control the timing of the capturing of image sequences by the sensor 208. As described herein, the language “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 210 may be configured (for example, by using corresponding programming stored in a memory as will be well understood by those skilled in the art) to carry out one or more of the steps, actions, and/or functions described herein.

In one form, the control circuit 210 may incorporate or be coupled to a memory and may incorporate or be coupled to a network interface and network(s). The memory can, for example, store non-transitorily computer instructions that cause the control circuit 210 to operate as described herein, when the instructions are executed, as is well known in the art. It is also contemplated that the memory may be used to store the image sequences captured by the sensor 208 (although one or more separate memory devices may be used to store the image sequences).

Further, the network interface may enable the control circuit 210 to communicate with other elements (both internal and external to the system 200). This network interface is well understood in the art. The network interface can communicatively couple the control circuit 210 to whatever network or networks may be appropriate for the circumstances. The control circuit 210 may be in communication with a server of the remote navigational control system 206 and may make use of cloud databases and/or operate in conjunction with a cloud computing platform. As can be seen in FIG. 2, the UAV control circuits 210 do not separately show the memory, network interface, and access to network(s) but instead these components are intended to be included as accessories to the UAV control circuits 210. Although the components are shown separately with respect to the navigational control circuit 216, the term “control circuit” is intended to have the same general meaning (and incorporate or coupling to memories and/or network interfaces).

Each UAV control circuit 210 autonomously navigates the UAV 202 from a starting point 104 along an initial flight path 102 to a navigational waypoint 106 according to autonomous operation without any human pilot navigation. In one form, it is contemplated that, in preparation for a delivery flight, the coordinates of a navigational waypoint 106 will be selected close to the customer's residence or other designated delivery location. A flight plan may then be preprogrammed and stored in the UAV control circuit 210. The UAV 202 will then be launched from the starting location 104 and proceed to the navigational waypoint 106. In one form, it is contemplated that the UAV control circuit 210 may use GPS tracking to navigate to the waypoint 106.

When the UAV 202 arrives at or approaches the waypoint 106, it then communicates with the remote navigational control system 206. It awaits instructions from the remote navigational control system 206 for landing the UAV 202. In one form, it is generally contemplated that the UAV 202 will hover at the waypoint 106 until it can hand over control of the navigation to the remote navigational control system 206. The length of this wait interval may be determined by certain established rules for the determining the landing order of in-flight UAVs, the number of other UAVs ahead of it in the queue 212, and the number of human pilots 213 that are available to land the in-flight UAVs. One example of rules for determining landing priority is addressed further below.

The UAV control circuits 210 are also configured to cooperate with sensor 208 to capture images of possible landing locations for the UAV 202 and transmit them to the remote navigational control system 206. The capturing of these images may be accomplished in various ways. In one form, it is contemplated that the handoff from autonomous navigation to a human pilot 213 may have occurred at the navigational waypoint 106 and that the human 213 has navigated the UAV 202 along a flight path to the designated delivery location 110. In one form, the waypoint 106 has been selected so that it is relatively close to the designated delivery location 110 and the flight path 108 may be relatively short. The human pilot 213 may orient the UAV 202 or the sensor 208 so as to view various possible touchdown locations and capture images of them. In another form, it is contemplated that the UAV control circuit 210 and sensor 208 may be configured to automatically capture a sequence of images, such as a panoramic, 360 degree view of the area surrounding the customer residence or designated delivery location 110. The human pilot 213 may then select a suitable touchdown location from the captured images. Accordingly, the UAV control circuits 210 guide the UAV 202 from the navigational waypoint 106 along a second flight path 108 to the landing location 110 based on human pilot navigation instructions from the remote navigational control system 206.

FIG. 2 also shows the remote navigational control system 206 configured to be operable by a human pilot 213 to control landing of the UAV 202. As can be seen, the remote navigational control system 206 includes a communication device 214 configured to communicate with a number of UAVs 202. This communication device 214 may be any of various types of transceivers or other communication devices that transmit and receive information and instructions.

In addition, the remote navigational control system 206 includes a navigation control circuit 216 that controls operation of the remote navigational control system 206. As described herein, the language “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 216 may be configured (for example, by using corresponding programming stored in a memory as will be well understood by those skilled in the art) to carry out one or more of the steps, actions, and/or functions described herein.

In one form, the navigational control circuit 216 may be coupled to a memory 218 and may be coupled to a network interface 220 and network(s) 222. The memory 218 can, for example, store non-transitorily computer instructions that cause the control circuit 216 to operate as described herein, when the instructions are executed, as is well known in the art. Further, the network interface may enable the control circuit 216 to communicate with other elements (both internal and external to the system 200). This network interface 220 is well understood in the art. The network interface 220 can communicatively couple the navigational control circuit 216 to whatever network or networks 222 may be appropriate for the circumstances. The navigational control circuit 216 may make use of cloud databases and/or operate in conjunction with a cloud computing platform. As can be seen in FIG. 2, the UAV control circuits 210 do not separately show the memory, network interface, and network but instead these components are intended to be included or incorporated as accessories to the UAV control circuits 210. Although the components are shown separately with respect to the navigational control circuit 216, the term “control circuit” is intended to have the same general meaning (and possibly incorporate or be coupled to memories and network interfaces).

In one form, it is contemplated that human pilots 213 may use virtual reality or augmented reality to facilitate the landing. In other words, the remote navigational control circuit 216 may be configured to guide the UAV 202 to the landing location 110 using virtual reality or augmented reality devices 224. So, in one optional form, the navigational control circuit 216 may be configured to transmit a 3D virtual reality environment to the human pilots 213 through a virtual reality interface and virtual reality system (but this is not required). For example, components of a virtual reality system may include a display device, a holographic display, an input device, audio devices, and motion sensors. The display device may present a virtual reality environment, and the user may utilize glasses to view possible landing locations and guide the UAV 202 to a landing. The glasses may be virtual reality glasses/goggles or augmented reality glasses/goggles. Input devices may include a touchscreen, a touchpad, a keyboard, a mouse, or any other suitable input device or combination of input devices. Also, motion sensors may detect the pilot's movement and reorient images presented on the display device in a manner consistent with the pilot's movements. The motion sensors may also be used to allow the pilot 213 to provide input via hand gestures or may track the pilot's eye movements. This general description provides just one example of a virtual reality set-up (which are fairly well known), and it should be understood that any conventional virtual reality arrangement is suitable.

Following completion of the delivery, the UAV 202 may return to its starting location 104, or base, to pick up more merchandise for deliveries to other customer locations. In one form, it is contemplated that this return trip may be handled autonomously by the UAV 202. In other words, the UAV control circuits 210 may be configured to autonomously navigate the UAV 202 along a third flight path from the landing location 110 to the starting location 104, according to autonomous operation without any human pilot navigation from the remote navigational control system 206. It is contemplated that the coordinates of the starting point 104 are known, and the UAV 202 may use these coordinates to return to the starting location 104, such as by GPS tracking.

As described herein, it is generally contemplated that the UAVs 202 are used to deliver merchandise to customers. However, it is also contemplated that UAVs 202 may be used for other purposes utilizing the systems and methods described herein. For example, one other type of UAV 202 is a service provider UAV. The UAV 202 may provide some sort of service (such as surveying land or inspection for property management) that may ultimately involve landing at some remote location. Another example is a first responder type of UAV 202, which may provide some sort emergency services (such as dropping off supplies or first aid in isolated areas). These service provider and first responder types of UAVs may be autonomously navigated to a certain waypoint and then navigated by a human pilot to a landing location.

In one form, it is contemplated that the human pilot(s) 213 may be selected in various ways. In one preferred form, the human pilots 213 are trained and dedicated to the task of guiding many UAVs 202 to various landing locations daily. However, it is also contemplated that human pilots 213 may be selected in other ways. For example, one way is crowdsourcing a pilot 213 (who may be a hobbyist or enthusiast). In other words, the remote navigational control circuit 216 may be configured to use crowdsourcing to determine a human pilot 213 to guide the UAV 202 to the landing location. Such an approach may require validation of the UAV pilot training and experience of any individual selected by crowdsourcing. Alternatively, in another form, the human pilot 213 may be the recipient himself, if he has sufficient expertise with drone navigation. Under such approaches, the UAV 202 may still employ autonomous sensors to avoid collisions and crashes.

In addition, the system 200 would preferably include a default mechanism in the event the UAV 202 receives no communication at the navigational waypoint 106 or to prevent its power level from falling below a minimum threshold. In one form, the UAV 202 would return to the starting location 104, or base, if a communication blackout occurred or if the UAV 202 detected a low power level. For example, the UAV control circuit 210 may be configured to return the UAV 202 to the starting location 104 if the control circuit 210 cannot communicate with the remote navigational control system 206 within a predetermined amount of time after arriving at the navigational waypoint 106 or if the power level falls below a predetermined minimum threshold. The power level may be monitored continually or periodically to ensure that sufficient power remains to allow the UAV 202 to return to its starting location 104.

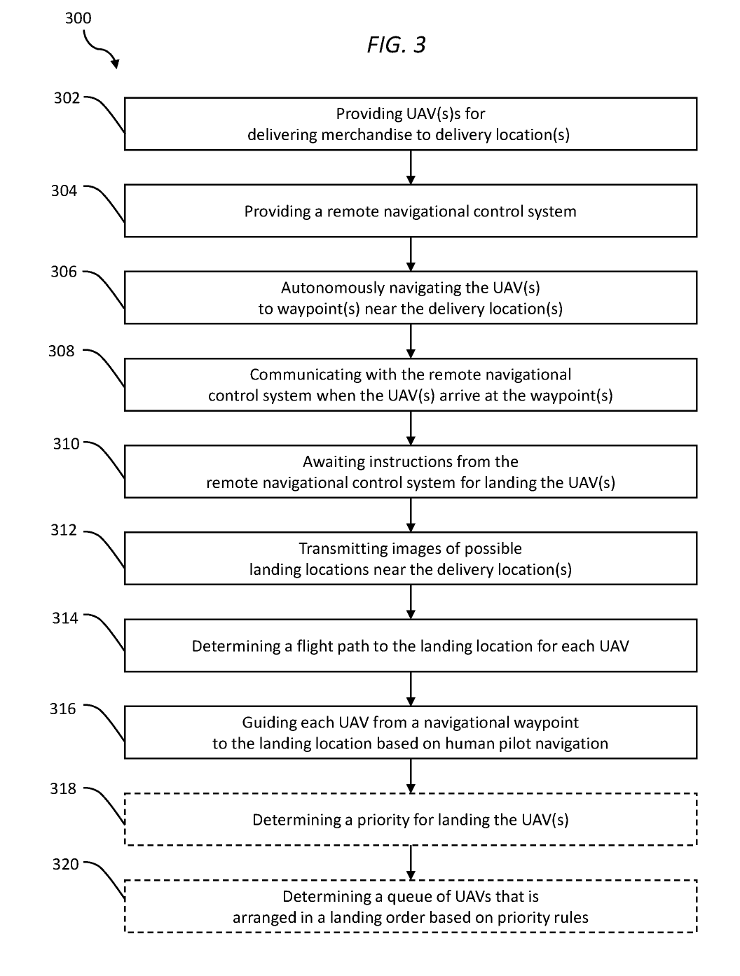

Referring to FIG. 3, there is shown a process 300 for using UAV(s) to deliver merchandise to delivery locations based on a divided control approach. More specifically, the process 300 contemplates autonomous navigation by the UAV up to a waypoint near the delivery location and then navigation by a human pilot to the landing location. Priority rules may be used to determine a landing order. The process 300 may use some or all of the components described above with respect to systems 100 and 200.

At block 302, one or more UAVs are provided for delivering merchandise to one or more delivery locations. In one form, it is generally contemplated that many UAVs may be simultaneously making deliveries of merchandise to different delivery locations. For example, a retailer fulfilling orders made by customers may employ a large number of UAVs for delivering the ordered merchandise items to the customers within a scheduled time period. These UAVs may depart from different starting locations, fly different flight paths, and arrive at different delivery locations.

At block 304, a remote navigational control system is provided. In one form, it is contemplated that the remote navigational control system may accommodate a number of human pilots, whose training and expertise are used to land numerous UAVs making deliveries of merchandise items to customers. It is contemplated that the remote navigational control system is in communication with each of the UAVs assigned to it, at least for the landing leg of the delivery flight.

At block 306, each UAV is autonomously navigated to a waypoint near the delivery location. In one form, a delivery location may be received as part of a customer's order or may be looked up in a customer database following placement of an order. The GPS coordinates of the delivery location may be determined, and a database of waypoints may be searched to determine a suitable one near the delivery location. The GPS coordinates for a selected waypoint may be stored in a memory coupled to or incorporated in a UAV control circuit, and the UAV control circuit may then autonomously navigate the UAV to the waypoint. Although the use of GPS navigation is described above, it is contemplated that other types of navigation to the waypoints may also be utilized.

At block 308, each UAV communicates with the remote navigational control system when it arrives at the selected waypoint. In one form, it is contemplated that each UAV need not communicate at all with the remote navigational control system on the first leg of its flight, i.e., from its starting location to the waypoint. However, this lack of communication is not required, and indeed, it may be desirable for the remote navigational control system to track each UAV along its entire flight path.

Once each UAV arrives at or approaches the waypoint, it is contemplated that the UAV will signal its arrival to the remote navigational control system. This communication or signaling may take various forms. In one form, it may be that the UAV has been tracked for the entire flight, and the signal simply shows that the UAV has now reached the waypoint. In other forms, there may be some sort of alert or notification that is provided to the remote navigational control system when the UAV arrives at the waypoint. For example, the UAV control circuit (or a navigational control circuit at the remote navigational control system) may be configured to provide this alert or notification when its tracking shows the UAV's arrival at the GPS coordinates of the waypoint.

At block 310, after arriving at the waypoint, each UAV awaits instructions from the remote navigational control system for landing the UAV. In one form, it is contemplated that each UAV may hover at the waypoint until it receives landing instructions and guidance from a human pilot. As addressed later herein, the length of wait time may depend on the UAV's position in a queue constituting a landing order of all UAVs simultaneously requiring landing instructions. In one form, it is also contemplated that it will not hover indefinitely but will take some sort of action before it loses power. For example, a control circuit of each UAV may be configured to return the UAV to the starting location if there is an inability to communicate with the remote navigational control system within a certain amount of time after arriving at the navigational waypoint, a human pilot does not transmit landing instructions within a certain amount of time, the power level of the UAV falls below a certain minimum threshold, or the rate of power depletion indicates that the UAV needs to return to the starting location for recharging.

At block 312, images are transmitted of possible landing locations near the delivery location. In one form, it is contemplated that these images are captured by an imaging sensor on the UAV and transmitted to the remote navigational control system. Further, the capture and transmission of these images may occur either before or after the handoff of control of the UAV to a human pilot. The steps of process 300 may occur in a different sequential order than shown in FIG. 3. In one form, the capture of these images may occur based on a panoramic sweep of the area about the waypoint. In another form, a human pilot may manipulate the orientation of the imaging sensor to obtain different views of the area surrounding the delivery location.

At block 314, after each UAV arrives at the waypoint, a flight path is determined from the waypoint to the landing location. Generally, at this stage, it is contemplated that the flight navigation is handed off to a human pilot for landing the UAV. Depending on the proximity of the waypoint to the landing location, the human pilot may use GPS or other navigational tools to fly from the waypoint to the landing location. Alternatively, the waypoint may be close enough that the human pilot can rely on images captured and transmitted by an imaging sensor. Further, it is contemplated that images of possible touchdown locations are captured and available for the human pilot to determine a suitable touchdown location, i.e., one that is reasonably close to the customer-designated delivery location and with terrain appropriate for landing, etc. Accordingly, at block 316, each UAV is guided from the waypoint to the landing location based on human pilot navigation.

At block 318, a priority is determined for landing the UAV(s). As stated, in one form, it is contemplated that numerous UAVs may be simultaneously making delivery flights along different flight paths to different customer-designated locations to deliver merchandise. So, there may be circumstances the number of UAVs that are ready to land exceeds the number of human pilots available to land them. In this situation, priority rules may be established to determine the UAV that most urgently needs to be landed first, as well as the order of importance of landing the remaining UAVs. Thus, at block 320, a queue of UAVs is determined that is arranged in a landing order based on rules of priority. One example of such rules of priority is addressed below.

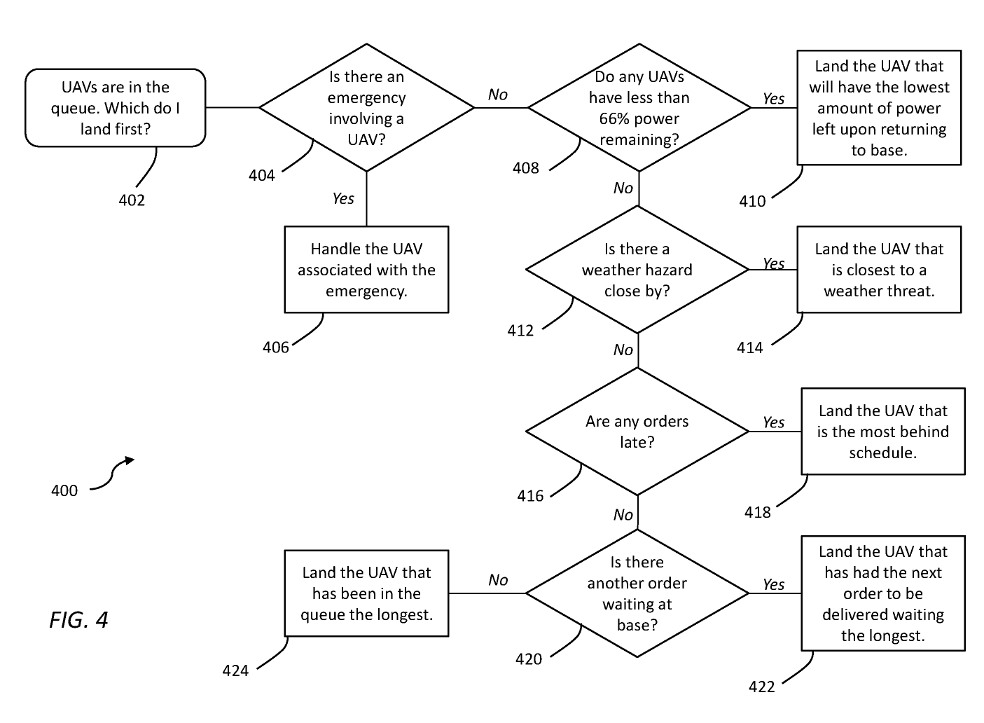

FIG. 4 shows a flow diagram of an exemplary process 400 for determining the landing order of multiple UAVs. The process 400 shows rules for determining which UAVs should receive priority in the landing order over other UAVs. It is generally intended to provide higher priority to those UAVs that need to land first for various reasons, such as UAVs experiencing an emergency, running low on power, etc., than other UAVs in different, less compelling circumstances.

At block 402, it is assumed that there are multiple UAVs whose order in a queue needs to be determined. In one form, it is contemplated that a navigation control circuit at a remote navigation control system continually adds, removes, and re-orders the UAVs in the queue. As time passes, UAVs that have completed landing may be removed from the queue, and new UAVs that have reached their waypoints are added to the queue. These new UAVs are added to the queue in an appropriate position depending on the application of the priority rules. This process 400 generally assumes that the number of UAVs who have arrived at their waypoints (and therefore need to land) exceeds the number of human pilots available. As should be evident, if the number of human pilots equals or exceeds the number of UAVs needing to land, each UAV can be landed immediately, and prioritization of UAVs may not be significant.

At block 404, in one form, the UAVs given the highest priority for landing are any UAVs that may be experiencing an emergency. Some examples of emergencies may include UAVs currently experiencing inclement weather (such as storms or high winds), damage to part of the UAV, mechanical malfunctions, loss of navigation or control, etc. These emergency conditions may be detected by databases coupled to the navigational control circuit (i.e., real time weather reports) or may be detected by UAV sensors (i.e., damage, mechanical malfunctions, loss of navigation or control). In one form, it is contemplated that a UAV control circuit may be continually or periodically monitoring various aspects of the flight and may communicate an alert when an emergency arises. In another form, it is contemplated that a navigational control circuit of a remote navigational control system is monitoring flight conditions of each of the UAVs and may thereby detect when emergency conditions arise.

If a UAV is experiencing an emergency condition, the process 400 moves to block 406. In other words, when an emergency condition arises and is detected, the UAV experiencing the emergency is given highest priority and moved to the head of the queue. A human pilot may then take over control of the UAV and make an immediate landing at the customer's delivery location or may make an immediate landing at any readily available touchdown location.

In summary, a first priority rule is to land a first subset of UAVs experiencing an emergency flight situation. In one form, the navigational control circuit may be configured to receive a communication from the first subset indicating an emergency flight situation. This receipt of a communication may arise in various ways, such as communication of an alert or notification by the UAV or by monitoring of the UAV by the navigational control circuit. The navigational control circuit may be configured to transmit instructions from a human pilot to guide the first subset of UAVs to available landing locations. The navigational control circuit may be configured to assign priority in the queue to the first priority rule ahead of other priority rules.

The process 400 then moves to block 408 where a low power level of UAVs is determined. In the example shown, it is determined whether any of the UAVs have less than 66% power remaining. As should be evident, the minimum power threshold may be set at any desired level, such as might be determined appropriate to complete landing of the UAV or to return the UAV to its starting point. In one form, it is contemplated that the UAVs are battery operated and the battery level of the UAVs are continually monitored, either by a UAV control circuit or by a navigational control circuit. It is contemplated that power may also be partially or completely provided by other power sources, such as solar, which power levels may be monitored.

If the power level of a UAV is below a predetermined threshold, the process 400 then moves to block 410. In block 410, in one form, the UAV will be landed first that will have the lowest amount of power left upon return to its starting location (base). In one form, a fixed minimum power threshold at the waypoint may be set by extrapolating the amount of power that will generally be required to land an UAV at a landing location and then fly it back to its starting location while optionally providing a comfortable safety margin. In another form, it is contemplated that the minimum threshold at the waypoint may be different for each UAV and may depend on other factors, such as the distance of the return flight back to the starting location and the rate of power depletion (see below). In this form, a calculation may be performed for each UAV to determine the amount of power left if each UAV were to complete its delivery and return to base, and UAVs may be given priority whose power levels would be the lowest after returning to base.

In another form, it is also contemplated that the rate of power depletion may be considered. The power levels may be detected at certain points in time and the time interval may be calculated in order to determine a rate of power depletion. There are several circumstances where the rate of power depletion may be high, such as when a UAV is transporting a relatively heavy merchandise item to a customer or when it is flying under windy conditions. Again, this rate of power depletion may be calculated by a UAV control circuit or a remote navigational control circuit. In this circumstance, where the rate of power depletion is high, a UAV may quickly run out of time to complete a landing and return to base, so it is generally desirable to be aware of this circumstance as soon as it can be detected.

In summary, a second priority rule is to land a second subset of UAVs with power levels or rates of power depletion exceeding a predetermined threshold. In this context, the term “exceeding” refers to going beyond a set limit, i.e., a power level falling below a minimum threshold or a rate of power depletion rising above a maximum threshold. For this circumstance, the remote navigational control circuit may be configured to receive a communication from the second subset indicating a power level or rate of power depletion exceeding the predetermined threshold. This power level or rate of power depletion may be monitored and calculated by either the UAV control circuit or by the remote navigational control circuit. Further, the remote navigational control circuit may be configured to then transmit instructions from a human pilot to guide each UAV of the second subset to a landing location. Thus, the remote navigational control circuit may be configured to assign priority in the queue to the second priority rule after the first priority rule (i.e., emergency flight conditions).

The process 400 then moves to block 412 where nearby weather conditions are determined. It is desirable to land UAVs with inclement weather (i.e., storms and/or high winds) nearby in order to possibly avoid this weather or minimize exposure to this weather. In one form, it is contemplated that changes in weather conditions may be detected by the UAV sensors. In another form, it is contemplated that the remote navigational control circuit may access weather databases to determine nearby weather conditions and to determine weather forecasts at the waypoint. Alternatively, the remote navigational control circuit may determine weather forecasts along the UAV's entire flight path between the starting location and customer delivery location.

If there is a weather hazard near a UAV, the process 400 then moves to block 414. In block 414, in one form, the UAV at a waypoint will be landed first that is closest to a weather hazard. In one form, the UAVs that are within a certain distance of a weather hazard may be determined and given priority in the queue. Where there is more than UAV within this subset, the UAV that is closest to a weather hazard may be given priority over another UAV that is more distant from a weather threat. In one form, these distances may be calculated by the remote navigational control circuit.

In summary, in one form, a third priority rule is to land a third subset of UAVs with predetermined weather conditions within a predetermined distance of the waypoint. These weather conditions may include winds above a certain minimum speed and/or conditions associated with storms. For this circumstance, the remote navigational control circuit may be configured to access a database to determine a weather forecast at the waypoint. Further, the remote navigational control circuit may be configured to then transmit instructions from a human pilot to guide each UAV of the third subset to a landing location. Thus, the remote navigational control circuit may be configured to assign priority in the queue to the third priority rule after the first and second priority rule (i.e., emergency flight conditions, power levels).

The process 400 moves to block 416 where the process 400 determines if any of the merchandise orders are late (e.g., behind schedule). As should be evident, it is desirable to deliver the merchandise to a customer at a scheduled delivery time or as soon thereafter as possible. In one form, it is contemplated that the scheduled delivery time is stored in a memory associated with the UAV control circuit and may be communicated to the remote navigational control circuit. In another form, it is contemplated that the navigational control circuit may access an order delivery database to determine scheduled times for delivery of UAVs in the queue.

If there is a UAV that is behind schedule, the process 400 then moves to block 418. In block 418, in one form, the UAV will be landed first that is the most behind schedule. In other words, if there is more than one UAV that is behind schedule, the navigational control circuit may compare the scheduled delivery times and give highest priority to the UAV in the subset that is the most behind schedule and the lowest priority to the UAV that is the least behind schedule.

In summary, in one form, a fourth priority rule is to land a fourth subset of UAVs that arrive at navigational waypoints after scheduled arrival times. The remote navigational control circuit may be configured to determine the scheduled arrival times of the plurality of UAVs and to determine the fourth subset. In one form, this information may be communicated by the UAV control circuit, or in another form, it may be determined by accessing an order delivery database containing scheduled delivery times. Further, the remote navigational control circuit may be configured to transmit instructions from a human pilot to guide each UAV of the fourth subset to its landing location. Thus, the remote navigational control circuit may be configured to assign priority in the queue to the fourth priority rule after the first, second, and third priority rules (i.e., emergency flight conditions, power levels, weather).

The process 400 moves to block 420 to determine if there is another order waiting for a UAV at its starting location (base). In this form, it is generally contemplated that a UAV will deliver a merchandise item to a customer delivery location and will then return to its base to pick up another merchandise item for a subsequent delivery. Further, in one form, it is contemplated that some or all of the UAVs may start their delivery flights from the same starting location (although this is not required). In one form, it is contemplated that subsequent delivery information is stored in a memory associated with the UAV control circuit and may be communicated to the remote navigational control circuit. In another form, it is contemplated that the navigational control circuit may access an order delivery database to determine subsequent delivery information for UAVs in the queue.

If there is at least one UAV with another order waiting for the UAV at its base, the process 400 then moves to block 422. At block 422, in one form, the UAV in this subset will be landed first that has its next delivery order waiting the longest. In other words, if there is more than one UAV that has an order waiting, the navigational control circuit may compare the subsequent delivery information and give highest priority to the UAV in the subset with the longest waiting order and the lowest priority to the UAV with the shortest waiting order.

In summary, in one form, a fifth priority rule is to land a fifth subset of UAVs that have a subsequent flight scheduled. These subsequent flights include orders waiting at a starting location (base) for subsequent delivery. In one form, the remote navigational control circuit may be configured to determine the flight schedules of the plurality of UAVs. This information may be communicated by the UAV control circuit or may be determined by accessing an order delivery database. Further, the remote navigational control circuit may then be configured to transmit instructions from a human pilot to guide each UAV of the fifth subset to its landing location. Thus, the remote navigational control circuit may be configured to assign priority in the queue to the fifth priority rule after the first, second, third, and fourth priority rules (i.e., emergency flight conditions, power levels, weather, behind schedule delivery).

The process 400 moves to block 424 to land the UAVs that have been in the queue the longest. In one form, it is generally contemplated that, as each UAV arrives at a waypoint and communicates with the remote navigational control system, it will be placed at the back of the queue. As other UAVs arrive, they will initially be placed behind earlier arriving UAVs, subject to application of the above priority rules. In other words, if a UAV is not subject to any of the above priority rules, it should be landed by a human pilot ahead of later arriving UAVs that are also not given priority under the above rules.

In summary, in one form, a sixth priority rule is to land a sixth subset of UAVs based on length of time in the queue. The remote navigational control circuit may be configured to determine the length of time of the plurality of UAVs in the queue to determine the sixth subset. In one form, it is contemplated this may be accomplished by placing each UAV at the end of the queue as each UAV arrives at its waypoint. Further, the remote navigational control circuit may be configured to transmit instructions from a human pilot to guide each UAV of the sixth subset to its landing location. Thus, the remote navigational control circuit may be configured to assign priority in the queue to the sixth priority rule after the first, second, third, fourth, and fifth priority rules (i.e., emergency flight conditions, power levels, weather, behind schedule delivery, subsequent order).

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A divided control system for combining both autonomous and human pilot navigation of unmanned aerial vehicles to deliver merchandise to landing locations, the system comprising:
a remote navigational control system configured to be operable by a human pilot to at least partially control a flight of an unmanned aerial vehicle (UAV); and
the unmanned aerial vehicle (UAV) comprising:
a two-way communication unit configured to communicate with the remote navigational control system;
a sensor configured to capture images of a landing location; and
a control circuit configured to:
autonomously navigate the UAV from a first starting point along a first flight path to a navigational waypoint according to autonomous operation without any human pilot navigation from the remote navigational control system;
communicate with the remote navigational control system when the UAV arrives at the navigational waypoint;
await instructions from the remote navigational control system for landing the UAV when the UAV arrives at the navigational waypoint;
transmit images of the landing location from the sensor to the remote navigational control system; and
guide the UAV from the navigational waypoint along a second flight path to the landing location based on human pilot navigation instructions from the remote navigational control system.

2. The system of claim 1, wherein the remote navigational control system comprises:
a communication device configured to communicate with a plurality of UAVs; and
a navigation control circuit coupled to the communication device and configured to:
determine a priority for landing at least one of the UAVs, each landing to be performed by one of a plurality of human pilots; and
determine a queue of the at least one UAV, the queue being arranged in a landing order based on predetermined priority rules for landing and stored by the navigational control circuit.

3. The system of claim 2, wherein:
a first priority rule is to land a first subset of UAVs experiencing an emergency flight situation;
the remote navigational control circuit is configured to receive a communication from the first subset indicating an emergency flight situation; and
the remote navigational control circuit is configured to transmit instructions from a human pilot to guide the first subset of UAVs to available landing locations;
wherein the remote navigational control circuit is configured to assign priority in the queue to the first priority rule ahead of other priority rules.

4. The system of claim 3, wherein:
a second priority rule is to land a second subset of UAVs with power levels or rates of power depletion exceeding a predetermined threshold;
the remote navigational control circuit is configured to receive a communication from the second subset indicating a power level or rate of power depletion exceeding a predetermined threshold; and
the remote navigational control circuit is configured to transmit instructions from a human pilot to guide each UAV of the second subset to its landing location;
wherein the remote navigational control circuit is configured to assign priority in the queue to the second priority rule after the first priority rule.

5. The system of claim 4, wherein:
a third priority rule is to land a third subset of UAVs with predetermined weather conditions within a predetermined distance of the navigational waypoint;
the remote navigational control circuit is configured to determine the third subset of UAVs with the predetermined weather conditions within the predetermined distance; and
the remote navigational control circuit is configured to transmit instructions from a human pilot to guide each UAV of the third subset to its landing location;
wherein the remote navigational control circuit is configured to assign priority in the queue to the third priority rule after the first and second priority rules.

6. The system of claim 5, wherein:
a fourth priority rule is to land a fourth subset of UAVs that arrive at navigational waypoints after scheduled arrival times;
the remote navigational control circuit is configured to determine the scheduled arrival times of the plurality of UAVs and to determine the fourth subset; and
the remote navigational control circuit is configured to transmit instructions from a human pilot to guide each UAV of the fourth subset to its landing location;
wherein the remote navigational control circuit is configured to assign priority in the queue to the fourth priority rule after the first, second, and third priority rules.

7. The system of claim 6, wherein:
a fifth priority rule is to land a fifth subset of UAVs that have a subsequent flight scheduled;
the remote navigational control circuit is configured to determine the flight schedules of the plurality of UAVs; and
the remote navigational control circuit is configured to transmit instructions from a human pilot to guide each UAV of the fifth subset to its landing location;
wherein the remote navigational control circuit is configured to assign priority in the queue to the fifth priority rule after the first, second, third, and fourth priority rules.

8. The system of claim 7, wherein:
a sixth priority rule is to land a sixth subset of UAVs based on length of time in the queue;
the remote navigational control circuit is configured to determine the length of time of the plurality of UAVs in the queue to determine the sixth subset; and
the remote navigational control circuit is configured to transmit instructions from a human pilot to guide each UAV of the sixth subset to its landing location;
wherein the remote navigational control circuit is configured to assign priority in the queue to the sixth priority rule after the first, second, third, fourth, and fifth priority rules.

9. The system of claim 1, wherein:
the remote navigational control circuit is configured to guide the UAV to the landing location using virtual reality or augmented reality devices.

10. The system of claim 1, wherein the UAV control circuit is configured to autonomously navigate the UAV along a third flight path from the landing location to the first starting location according to autonomous operation without any human pilot navigation from the remote navigational control system.

11. The system of claim 1, wherein the remote navigational control circuit is configured to use crowdsourcing to determine a human pilot to guide the UAV to the landing location.

12. The system of claim 1, wherein the UAV control circuit is configured to:
return the UAV to the first starting location if the UAV control circuit cannot communicate with the remote navigational control system within a first predetermined amount of time after arriving at the navigational waypoint, a human pilot does not transmit landing instructions to the UAV within a second predetermined time after the UAV arrives at the waypoint, the power level of the UAV falls below a third predetermined minimum threshold, or the rate of power depletion of the UAV exceeds a fourth predetermined maximum threshold.

13. A method for combining both autonomous and human pilot navigation of unmanned aerial vehicles to deliver merchandise to landing locations, the method comprising:
providing a remote navigational control system configured to be operable by a human pilot to at least partially control a flight of an unmanned aerial vehicle (UAV);
providing an unmanned aerial vehicle (UAV) comprising:
a two-way communication unit configured to communicate with a remote navigational control system;
a sensor configured to capture images;
a control circuit operatively coupled to the two-way communication unit and the sensor;
autonomously navigating the UAV from a first starting point along a first flight path to a navigational waypoint according to autonomous operation without any human pilot navigation from the remote navigational control system;
communicating with the remote navigational control system when the UAV arrives at the navigational waypoint;
awaiting instructions from the remote navigational control system for landing the UAV when the UAV arrives at the navigational waypoint;
transmitting images of the landing location from the sensor to the remote navigational control system;
determining a second flight path from the navigational waypoint to a landing location; and
guiding the UAV from the navigational waypoint along a second flight path to the landing location based on human pilot navigation instructions from the remote navigational control system.

14. The method of claim 13, further comprising, by the remote navigational control system:
communicating with a plurality of UAVs;
determining a priority for landing at least one of the UAVs, each landing to be performed by one of a plurality of human pilots; and
determining a queue of the at least one UAV, the queue being arranged in a landing order based on predetermined priority rules for landing.

15. The method of claim 14, wherein a first priority rule is to land a first subset of UAVs experiencing an emergency flight situation, the method further comprising, by the remote navigational control system:
receiving a communication from the first subset indicating an emergency flight situation;
transmitting instructions from a human pilot to guide the first subset of UAVs to available landing locations; and
assigning priority in the queue to the first priority rule ahead of other priority rules.

16. The method of claim 15, wherein a second priority rule is to land a second subset of UAVs with power levels or rates of power depletion exceeding a predetermined threshold, the method further comprising, by the remote navigational control system:
receiving a communication from the second subset indicating a power level or rate of power depletion exceeding a predetermined threshold;
transmitting instructions from a human pilot to guide each UAV of the second subset to its landing location; and
assigning priority in the queue to the second priority rule after the first priority rule.

17. The method of claim 16, wherein a third priority rule is to land a third subset of UAVs with predetermined weather conditions within a predetermined distance of the navigational waypoint, the method further comprising, by the remote navigational control system:
determining the third subset of UAVs with the predetermined weather conditions within the predetermined distance;
transmitting instructions from a human pilot to guide each UAV of the third subset to its landing location; and
assigning priority in the queue to the third priority rule after the first and second priority rules.

18. The method of claim 17, wherein a fourth priority rule is to land a fourth subset of UAVs that arrive at navigational waypoints after scheduled arrival times, the method further comprising, by the remote navigational control system:
determining the scheduled arrival times of the plurality of UAVs and to determine the fourth subset;
transmitting instructions from a human pilot to guide each UAV of the fourth subset to its landing location; and
assigning priority in the queue to the third priority rule after the first, second, and third priority rules.

19. The method of claim 18, wherein a fifth priority rule is to land a fifth subset of UAVs that have a subsequent flight scheduled, the method further comprising, by the remote navigational control system:
determining the flight schedules of the plurality of UAVs;
transmitting instructions from a human pilot to guide each UAV of the fifth subset to its landing location; and
assigning priority in the queue to the fifth priority rule after the first, second, third, and fourth priority rules.

20. The method of claim 19, wherein a sixth priority rule is to land a sixth subset of UAVs based on length of time in the queue, the method further comprising, by the remote navigational control system:
determining the length of time of the plurality of UAVs in the queue to determine the sixth sub set;
transmitting instructions from a human pilot to guide each UAV of the sixth subset to its landing location; and
assigning priority in the queue to the sixth priority rule after the first, second, third, fourth, and fifth priority rules.

21. The method of claim 13, further comprising, by a UAV control circuit:
autonomously navigating a UAV along a third flight path from the landing location to the first starting location according to autonomous operation without any human pilot navigation from the remote navigational control system.

22. The method of claim 13, further comprising, by a UAV control circuit:
returning a UAV to the starting location if the control circuit cannot communicate with the remote navigational control system within a first predetermined amount of time after arriving at the navigational waypoint, a human pilot does not transmit landing instructions to the UAV within a second predetermined time after the UAV arrives at the waypoint, the power level of the UAV falls below a third predetermined minimum threshold, or the rate of power depletion of the UAV exceeds a fourth predetermined maximum threshold.
